(19) United States
(12) Patent Application Publication
(10) Pub. No.: US 2007/0296270 A1
(43) Pub. Date: Dec. 27, 2007

(54) SOLENOID VALVE FOR CONTROLLING THE FLOW OF BRAKE OIL

(75) Inventor: Sung-Jun PARK, Gyeonggi-do (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Seoul (KR)

(21) Appl. No.: 11/533,151

(22) Filed: Sep. 19, 2006

(30) Foreign Application Priority Data
Jun. 23, 2006 (KR) 10-2006-0056826

(51) Int. Cl. B60T 8/36

(52) U.S. Cl. 303/119.2

(57) ABSTRACT

A solenoid valve includes a valve body defining a chamber that receives a plunger actuated by an armature, having flow path forming holes which are radially defined to serve as flow paths of a brake hydraulic line extending between a master cylinder and a brake mechanism, and fitted into a pump housing, a plunger seat accommodated in the valve body and applied with hydraulic pressure supplied from the master cylinder, a main check valve that opens and closes the flow paths through detachment and attachment between the contact end of the plunger and the plunger seat to switch flow of hydraulic pressure from the plunger seat through the valve body to the brake mechanism, and a return check valve to return oil in an axial direction, which is parallel to the plunger seat axially accommodated in the chamber and perpendicular to the flow path forming holes.

### CROSS-REFERENCE TO RELATED APPLICATIONS

The present application is based on, and claims priority from, Korean Application Serial Number 10-2006-0056826, filed on Jun. 23, 2006, the disclosure of which is hereby incorporated by reference herein in its entirety.

### FIELD OF THE INVENTION

The present invention relates, in general, to a solenoid valve for a motor vehicle, and, more particularly, to a solenoid valve for controlling the flow of brake oil, which operates to ensure quick and reliable flow of brake oil.

### BACKGROUND OF THE INVENTION

As is well known in the art, in a brake system, hydraulic pressure which boosts the stepping force applied by a driver to a brake pedal, is used to stop a moving vehicle. Since this brake system has a simple construction of clamping rotating wheels and stopping or slowing rotation of wheels, braking performance that is optimized in conformity with a traveling situation of the vehicle and road conditions cannot be realized.

In order to overcome the limitations of the simple braking system and improve the traveling stability of the vehicle, an anti-lock brake system (ABS) for preventing wheels from being locked by appropriately adjusting braking pressure applied to the wheels depending upon the slip rate of the wheels calculated based on the velocity of the wheels, or a traction control system (TCS) for adjusting the driving force of an engine to prevent the wheels from excessively slipping upon abrupt start or rapid acceleration, is used.

However, even in the case of the anti-lock brake system or the traction control system, satisfactory performance is realized only when the vehicle travels on a straight road. When the vehicle travels on a curved road, it is difficult to completely control understeer, in which the vehicle is excessively tilted outward, or oversteer, in which the vehicle is excessively tilted inward, and reliability, promoting the stability of the vehicle, may be degraded.

Recently, an electronic stability program (ESP) system has been disclosed in the art. The ESP system determines whether oversteer or understeer is occurring by analyzing the measurement signals input from a wheel velocity sensor, a yaw rate sensor, a lateral acceleration sensor and a steering angle sensor in order to consider braking, driving and steering systems together to thereby control the vehicle in an orchestrated manner. Therefore, as the error between the traveling direction of the vehicle desired by the driver and the actual traveling direction of the vehicle is minimized, the traveling direction of the vehicle intended by the user can be reliably maintained under any driving conditions.

In the case of the ESP system, separately from a brake line for supplying hydraulic braking pressure between from master cylinder to wheels, braking pressure is supplied to the wheels by pumping oil from the master cylinder so as to prevent the vehicle from unintentionally spinning (for example, on a frozen road). A solenoid valve, which is also called a high pressure shuttle valve (HSV), is disposed between the master cylinder and a pump to define flow paths of oil.

If rear wheels reach a limit in rotating contact between tires and a road, or excessive cornering force is applied to the outside front wheel when cornering, the oversteer phenomenon, in which the vehicle turns more sharply than the steering angle desired by the driver, occurs. At this time, the ESP system controls the braking apparatus of the front wheels and decreases excessive cornering moment generated by the front wheels.

Also, if front wheels reach a limit in rotating contact between tires and a road or excessive cornering force is applied to the inside rear wheel upon cornering, the understeer phenomenon, in which the vehicle turns less than the steering angle desired by the driver, occurs. At this time, the ESP system controls the braking apparatus to guide the vehicle in the direction desired by the driver, thereby improving the stability and steerability of the vehicle.

Nevertheless, in order to ensure the proper operation of the ESP system, the flow of brake oil, that is, the supply and return of brake oil, must be conducted extremely quickly between the master cylinder and brake mechanisms mounted to the wheels. To this end, the development of a solenoid valve capable of ensuring the quick supply and discharge of brake oil is required, the performance of such a solenoid valve determining the performance of the entire ESP system.

### SUMMARY OF THE INVENTION

Embodiments of the present invention provide a solenoid valve which defines the flow path of brake oil between a master cylinder and a brake mechanism and ensures the quick supply and return of brake oil, thereby having reliable responsiveness.

According to one aspect of the present invention, there is provided a solenoid valve for supplying hydraulic braking pressure from a master cylinder to a brake mechanism by means of a booster for boosting stepping force of a brake pedal, the solenoid valve comprising a plunger actuated by an armature wound by a coil supplied with power when the brake pedal is stepped, and formed on a distal end portion thereof with a contact end for opening and closing a flow path; a valve body defining a first chamber for receiving the plunger, having flow path forming holes which are radially defined to serve as flow paths of a brake hydraulic line extending between the master cylinder and the brake mechanism, and fitted into a pump housing; a plunger seat accommodated in the valve body and applied with hydraulic pressure supplied from the master cylinder to supply oil through the flow path forming holes of the valve body; a spring elastically disposed between the plunger and the plunger seat; a main check valve for opening and closing the flow paths through detachment and attachment between the contact end of the plunger and the plunger seat to allow and prevent the flow of hydraulic pressure from the plunger seat through the valve body to the brake mechanism; and a return check valve for returning oil in an axial direction, which is parallel to the plunger seat axially accommodated in the first chamber of the valve body and is perpendicular to the flow path forming holes.

According to another aspect of the present invention, the solenoid valve further comprises a support member inserted into the valve body to be positioned adjacent to the plunger seat and to support the plunger seat; and a front filter coupled to the distal end of the valve body to remove impurities contained in oil, and forcibly fitted into the pump housing to be tightly supported by the pump housing.

According to another aspect of the present invention, the valve body comprises an elongate body part secured to a housing surrounding the armature wound by the coil, a first flow path-forming body part formed integrally with the elongate body part and fitted into and fastened to the pump housing, a fastening flange formed between the elongate body part and the first flow path-forming body part to have an increased diameter, and forcibly fastened to the pump housing, the flow path forming holes radially defined in the first flow path forming body part to communicate with the first chamber axially defined through center portions of the elongate body part and the first flow path forming body part and to supply hydraulic pressure to the brake mechanisms and a returning flow path axially defined parallel to the plunger seat axially accommodated in the first chamber of the valve body and perpendicular to the flow path forming holes to provide a return passage when oil is returned.

According to another aspect of the present invention, the plunger seat comprises a second flow path forming body part defining a second chamber into which oil is introduced from the master cylinder, and an elongate contact end projecting from a distal end of the second flow path forming body part and defining a guide hole which communicates with the second chamber.

According to still another aspect of the present invention, the valve body, which is forcibly fitted into and fastened to the pump housing, has a first fastening element which is fastened by a first fastening part formed by plastic deformation of an inner surface of the pump housing at an entrance of a third chamber defined in the pump housing, and a second fastening element, which is spaced apart from the first fastening element and is fastened by a second fastening part formed by plastic deformation of the inner surface of the pump housing.

According to a still further aspect of the present invention, an edge of a bottom of the third chamber of the pump housing is formed with an inclined support, such that, with the valve body fitted into the pump housing, the proximal end of the front filter inserted into the third chamber of the pump housing, is brought into tight contact with the inclined support.

### BRIEF DESCRIPTION OF THE DRAWINGS

For a better understanding of the nature and objects of the present invention, reference should be made to the following detailed description with the accompanying drawings, in which:

FIG. 1 is a cross-sectional view illustrating the construction of a solenoid valve for controlling the flow of brake oil in accordance with an embodiment of the present invention;

FIG. 2 is a cross-sectional view illustrating the assembled state of the solenoid valve in accordance with the embodiment of the present invention; and

FIG. 3 is a cross-sectional view illustrating the flow of hydraulic pressure when brake oil is supplied through the solenoid valve in accordance with the embodiment of the present invention.

### DETAILED DESCRIPTION OF THE PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

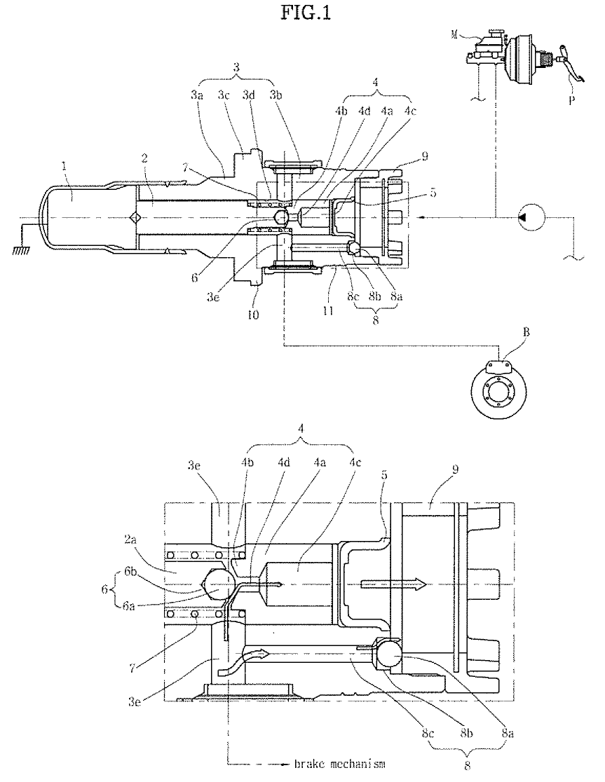

FIG. 1 is a cross-sectional view illustrating the construction of a solenoid valve for controlling the flow of brake oil in accordance with an embodiment of the present invention. The solenoid valve according to the present invention functions to supply hydraulic braking pressure, generated in a master cylinder M, through a booster for boosting the stepping force of a brake pedal P, to a brake mechanism B mounted to a wheel disc. The solenoid valve comprises a plunger 2 actuated by an armature 1 wound by a coil 1a supplied with power in response to a control signal from a control unit when the brake pedal B is stepped, and formed oil the distal end portion thereof with a contact end 2a for opening and closing a flow path; a valve body 3 defining a first chamber 3d for receiving the plunger 2, having flow path forming holes 3e which are radially defined to serve as flow paths of a brake hydraulic line extending between the master cylinder M and the brake mechanism B, and fitted into a pump housing PH; a plunger seat 4 accommodated in the valve body 3 and applied with hydraulic pressure supplied from the master cylinder M to supply oil through the flow path forming holes 3c of the valve body 3; a spring 7 elastically disposed between the plunger 2 and the plunger scat 4; a main check valve 6 for opening and closing the flow paths through detachment and attachment between the contact end 2a of the plunger 2 and the plunger seat 4 to allow and prevent the flow of hydraulic pressure from the plunger seat 4 through the valve body 3 to the brake mechanism B; and a return check valve 8 for returning oil in an axial direction which is parallel to the plunger seat 4 axially accommodated in the first chamber 3d of the valve body 3, and is perpendicular to the flow path forming holes 3e.

The solenoid valve further comprises a support member 5 inserted into the first chamber 3d of the valve body 3 to be positioned adjacent to the plunger seat 4, support the plunger seat 4 and restrain movement of the plunger seat 4; and a front filter 9 coupled to the distal end of the valve body 3 to remove impurities contained in oil, and forcibly fitted into the pump housing PH to be tightly supported by the pump housing PH.

### The filter body of the front filter 9 is made through injection molding.

The valve body 3 comprises an elongate body part 3a secured to a housing surrounding the armature 1 wound by the coil 1a, a first flow path forming body part 3b formed integrally with the elongate body part 3a and fitted into and fastened to the pump housing PH, a fastening flange 3c, formed between the elongate body part 3a and the first flow path forming body part 3b to have an increased diameter and forcibly fastened to the pump housing PH, the flow path forming holes 3e radially defined in the first flow path forming body part 3b to communicate with the first chamber 3d axially defined through the center portions of the elongate body part 3a and the first flow path forming body part 3b and to supply hydraulic pressure to the brake mechanism B, and a returning flow path 8c axially defined parallel to the plunger seat 4 axially accommodated in the first chamber 3d of the valve body 3 and perpendicular to the flow path forming holes 3e to provide a return passage when oil is returned.

The plunger seat 4 comprises a second flow path forming body part 4a defining a second chamber 4c into which oil is introduced from the master cylinder M, and an elongate contact end 4b projecting from the distal end of the second flow path forming body part 4a and defining a guide hole 4d which communicates with the second chamber 4c.

Further, the main check valve 6 comprises a first spherical check hall 6a, which is accommodated in a first accommodating groove 6b defined in the contact end 2a of the plunger 2, and opens and closes the flow path depending upon the degree of contact with the plunger seat 4. The end surface of the contact end 2a of the plunger 2, in which the first spherical check ball 6a is accommodated, and the end surface of the elongate contact end 4b of the plunger seat 4, which come into contact with each other, are formed in the shape of an arc to ensure tight contact therebetween.

At this time, the arc-shaped contact surfaces of the contact end 2a and the elongate contact end 4b are formed in a manner such that, when the contact end 2a of the plunger 2 has a convex arc-shaped contour, the elongate contact end 4b of the plunger seat 4 has a concave arc-shaped contour, or vice versa.

The return check valve 8 comprises a second spherical check ball 8a which is accommodated in a second accommodating groove 8b defined in an end of the returning flow path 8c, axially defined parallel to the plunger seat 4 axially accommodated in the first chamber 3d of the valve body 3 and perpendicular to the flow path forming holes 3e.

In addition, when the solenoid valve is forcibly fitted along with a stake into and fastened to the pump housing PH, the solenoid valve forms multiple sealing structures. That is to say, when a first fastening element 10 for reinforcing the fastening force and airtight function of the valve body 3 is forcibly fitted along with the stake through the entrance of the pump housing PH, the pump housing PH undergoes plastic deformation. Further, when a second fastening element 11, which is spaced apart from the first fastening element 10, is forcibly fitted into the pump housing PH, the pump housing PH undergoes plastic deformation. To this end, the portion of the pump housing PH, into which the first and second fastening elements 10 and 11 are fitted, is made of aluminum which has a relatively low yield strength.

The second fastening element 11 comprises a plurality of grooves which are defined at regular intervals on the circumferential outer surface of the first flow path-forming body part 3b of the valve body 3. While the grooves have various sectional shapes, it is preferred that each groove has a V-shaped section.

The distal end portion of the first flow path forming body part 3b of the valve body 3, which is inserted into the pump housing PH and is not defined with the second fastening element 11, has a diameter relatively smaller than that of the portion of the first flow path-forming body part 3b which is defined with the second fastening element 11. This is to prevent plastic deformation of a third chamber 12 of the pump housing PH by the distal end portion of the first flow path-forming body part 3b when the first flow path-forming body part 3b is forcibly fitted into the third chamber 12 defined in the pump housing PH.

The third chamber 12 defined in the pump housing PH is formed in a multi-stepped manner to have different inner diameter portions such that the valve body 3 having different outer diameter portions, that is, the fastening flange 3c and the first flow path forming body part 3b which constitute the valve body 3 and have different outer diameters, can be appropriately fitted into the pump housing PH while being engaged with the corresponding portions of the third chamber 12.

The edge of the bottom of the third chamber 12 of the pump housing PH is formed with an inclined support 12a. When the valve body 3 of the solenoid valve is fitted into the pump housing PH, as shown in FIG. 9, the front filter 9 coupled to the distal end of the valve body 3 is brought into tight contact with the inclined support 12a, as a result of which the front filter 9 is prevented from being released by the returning pressure of oil when oil is returned to the master cylinder M.

Hereafter, the operation of the solenoid valve according to the present invention will be described with reference to the attached drawings.

The solenoid valve of the present invention prevents driving stability of a vehicle from being degraded by an oversteer or understeer phenomenon which occurs in wheels when turning quickly, or on a slippery road such as an icy road. In other words, irrespective of whether or not a driver steps on a brake pedal, an LISP system is operated based on signals received from various sensors installed on the vehicle to ensure traveling stability of the vehicle even when an unexpected situation occurs.

When a brake pedal is stepped on, as shown in FIG. 1, in a brake hydraulic circuit arranged between the master cylinder M and the brake mechanism B, the solenoid valve operates such that oil can be quickly supplied and returned. To this end, the solenoid valve defines flow paths for ensuring the quick supply and return of oil, and at the same time, is configured to have structures capable of realizing multiple sealing effects and increasing fastening force.

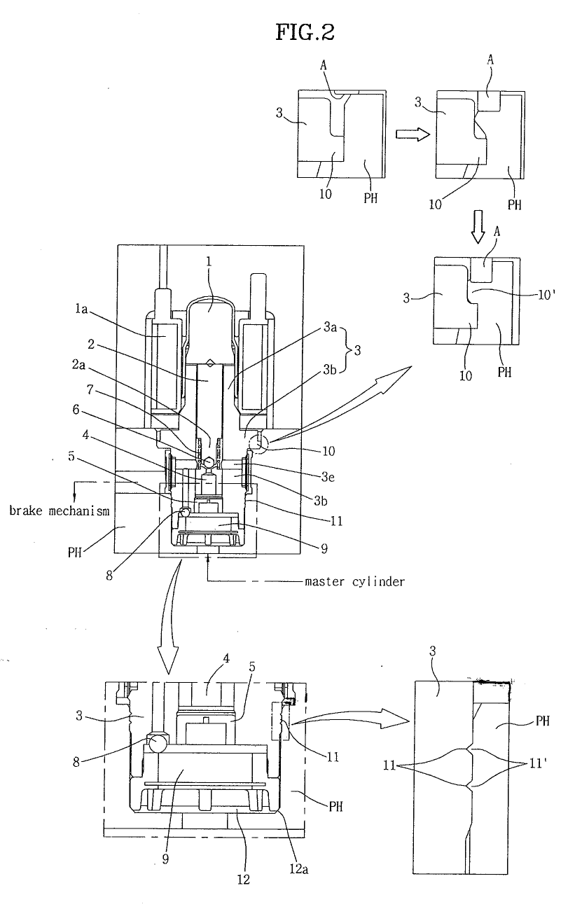

Between these two aspects of the solenoid valve, structures for increasing fastening force and realizing multiple sealing effects will be first described. Referring to FIG. 2, a primary fastening and sealing structure is formed by the fastening flange 3c of the valve body 3, which has a relatively large diameter and is positioned between the elongate body part 3a of the valve body 3 coupled with the plunger 2 and the first flow path forming body part 3b, defining flow paths and fitted into and fastened to the pump housing PH. A secondary fastening and sealing structure is formed by the first flow path forming body part 3b, which is forcibly inserted into the third chamber 12 of the pump housing PH.

In the fastening flange 3c of the valve body 3 and the pump housing PH which constitute the primary fastening and sealing structure, as best shown in FIG. 2, after the first flow path forming body part 3b of the valve body 3 is forcibly fitted into the third chamber 12 of the pump housing PH along with the stake, a first fastening part 10′, which is made of aluminum and is plastically deformed by a downwardly pressed sealing member A, is moved onto the first fastening element 10, which projects from the fastening flange 3c and is seated in the entrance of the third chamber 12 of the pump housing PH.

That is to say, as the first fastening part 10′ is plastically deformed, the deformed portion is moved into the space defined between the fastening flange 3c and the first fastening element 10. As a consequence, the first fastening element 10 is covered by the first fastening part 10′ to generate fastening force in cooperation with the sealing member A, and the sealing effect is improved because it is covered by the first fastening part 10′.

Further, in the secondary fastening and sealing structure which is formed by the first flow path forming body part 3b of the valve body 3 and the third chamber 12 of the pump housing PH, as best shown in FIG. 2, as the distal end portion of the first flow path forming body part 3b is forcibly fitted into the third chamber 12 of the pump housing PH along with the stake, a second fastening part 11′, which is formed by the plastic deformation of the inner wall of the third chamber 12, is introduced into the second fastening element 11 which is formed on the circumferential outer surface of the first flow path forming body part 3b to have the V-shape section. As a consequence, the second fastening element 12 has increased fastening force and performs a scaling function on the inner wall of the third chamber 12.

Here, the second fastening element 11, which is formed on the first flow path forming body part 3b, can sufficiently perform a sealing function even without using a separate sealing ring (O-ring). Therefore, the number of required sealing rings can be decreased, and it is not necessary to perform work for installing the sealing rings.

When the distal end portion of the first flow path forming body part 3b is forcibly fitted into the third chamber 12 of the pump housing PH along with the stake, the distal end portion of the first flow path forming body part 3b plastically deforms the third chamber 12 due to the fact that the distal end portion of the first flow path forming body part 3b has a relatively smaller diameter than the portion of the first flow path forming body part 3b which is formed with the second fastening element 11

Also, the front filter 9, which is coupled to the distal end of the first flow path forming body part 3b constituting the valve body 3 to remove impurities contained in oil, is positioned in the third chamber 12 of the pump housing PH. At this time, as best shown in FIG. 2, as the distal end portion of the valve body 3 is inserted into the pump housing PH, the front filter 9 is brought into contact with the inclined support 12a which is inclined in such a way as to decrease the diameter of the third chamber 12 of the pump housing PH.

The inclined support 12a of the third chamber 12, with which the front filter 9 is brought into contact to be supported thereby, prevents the front filter 9 from being released by the pressure of oil returning toward the master cylinder M. Also, the inclined support 12a precisely maintains the distance between the front filter 9 and the second check ball 8a to prevent the second check ball 8a, for opening and closing the returning flow path 8c defined in the first flow path forming body part 3b of the valve body 3, from being released from the second accommodating groove 8b.

Regarding the functioning of the hydraulic braking circuit using the solenoid valve coupled to the pump housing PH as described above, hydraulic pressure is supplied from the master cylinder M through the solenoid valve to the brake mechanism B when the brake pedal is stepped on, and hydraulic pressure return flow is produced in the brake mechanism B through the solenoid valve towards the master cylinder M, which will be described below.

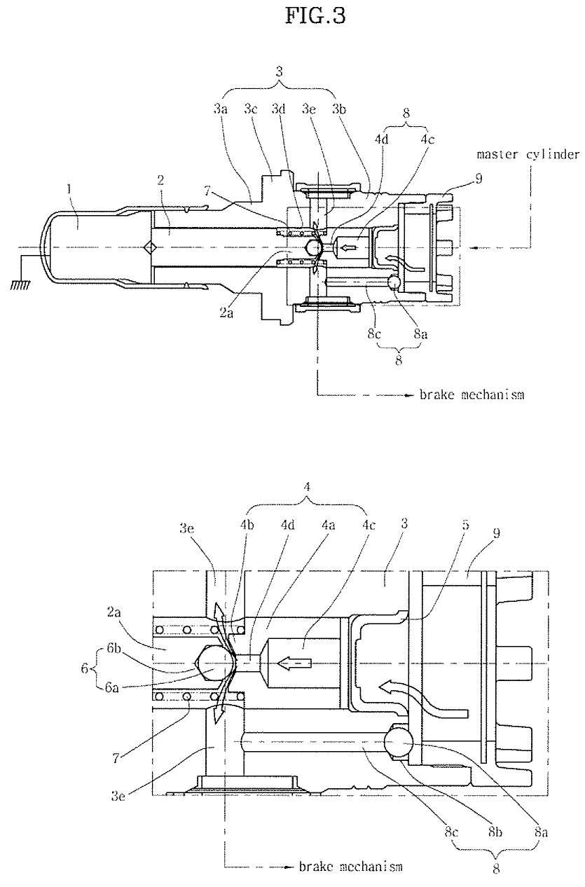

First, when the brake pedal is stepped on, braking pressure transmitted from the master cylinder M is supplied to the brake mechanism B through the solenoid valve. As shown in FIG. 3, in the hydraulic pressure supply flow through the solenoid valve, hydraulic pressure is introduced into the first chamber 3d of the valve body 3 through the front filter 9. At this time, in the solenoid valve, as the plunger 2, which is actuated by the armature 1, energized by power supplied to the coil 1a, opens the main check valve 6, a flow path is created.

Then, the hydraulic braking pressure introduced into the first chamber 3d of the valve body 3 flows into and is then discharged through the second chamber 4c and the guide hole 4d of the plunger seat 4. Thereafter, the hydraulic braking pressure flows through the flow path, which is opened by the main check valve 6 separated from the plunger seat 4 together with the plunger 2.

The hydraulic pressure discharged into the first chamber 3d of the valve body 3 through the plunger seat 4 is supplied to the brake mechanism B through the flow path forming holes 3e, which are radially defined in the valve body 3 to provide pressure for operating the brake mechanism B to thereby perform a braking function.

At this time, the returning flow path 8c defined in the valve body 3 is closed by the hydraulic pressure transmitted from the master cylinder M, that is, due to the fact that the second check ball 8a for opening and closing the returning flow path 8c is positioned on the flow path of the hydraulic braking pressure.

Meanwhile, when the brake pedal is released, a flow path is created so that oil can be returned from the brake mechanism B through the solenoid valve to the master cylinder M. This is because, if the hydraulic braking pressure is not applied from the master cylinder M to the solenoid valve, hydraulic pressure is applied from the brake mechanism B to the solenoid valve.

As the hydraulic pressure produced when the brake pedal is stepped on is removed, the hydraulic pressure flow from the brake mechanism B toward the solenoid valve is created in two ways. Namely, as can be readily seen from FIG. 1, on the one hand, hydraulic pressure flow is created through the main check valve 6 toward the plunger seat 4, and on the other hand, returning hydraulic pressure flow is created through the return check valve 8 arranged in the axial direction of the valve body 3.

Concretely speaking, with the main check valve 6 opened, one part of the returning hydraulic pressure is introduced into the guide hole 4d of the plunger seat 4 through the flow path forming holes 3e defining the flow path of the valve body 3, discharged through the second chamber 4c communicating with the guide hole 4d, and then returned to the master cylinder M via the front filter 9.

Furthermore, the other part of the returning hydraulic pressure, which does not flow toward the main check valve 6, flows through the return check valve 8 disposed in the returning flow path 8c, which is defined in the axial direction to be perpendicular to the flow path forming holes 3e. That is to say, as the returning hydraulic pressure, which flows toward the returning flow path 8c, applies pressure to the second spherical 2a check ball 8a, which is accommodated in the second accommodating groove 8b defined at the end of the returning flow path 8c, the returning flow path 8c is opened.

Then, as the returning hydraulic pressure introduced into the returning flow path 8c with the return check valve 8 opened is discharged from the returning flow path 8c, the returning hydraulic pressure is returned to the master cylinder M through the front filter 9 coupled to the valve body 3.

At this time, the front filter 9 limits to some extent the movement of the check ball 8a, which is pushed by returning hydraulic pressure.

Therefore, as the returning hydraulic pressure is formed in two ways, that is, through the main check valve 6 and the return check valve 8, the return responsiveness of the returning hydraulic pressure, which returns from the brake mechanism B to the master cylinder M, is significantly improved.

As is apparent from the above description, the solenoid valve for controlling the flow of brake oil according to the present invention provides advantages in that a return flow path, which is defined from a brake mechanism to a master cylinder through the solenoid valve when releasing a braking state, comprises a hydraulic pressure flow path, which is already defined from the master cylinder to the brake mechanism through the solenoid valve when braking, and a separately defined return flow path. Thus, as the returnability of hydraulic pressure is improved, reliable responsiveness of the solenoid valve is accomplished.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A solenoid valve for supplying hydraulic braking pressure from a master cylinder to a brake mechanism by using a booster for boosting a stepping force of a brake pedal, the solenoid valve comprising:
a plunger configured to be actuated by an armature having a coil winding which is supplied with power when the brake pedal is stepped, and a distal end portion thereof with of the plunger having a contact end configured to open and close a flow path;
a valve body defining a plunger receiving chamber which receives the plunger, the valve body having flow path forming holes extending radially within the valve body so as to provide flow paths of a brake hydraulic line which extends between the master cylinder and the brake mechanism, wherein the valve body is configured to be fitted into and fastened to a pump housing, the valve body having a first fastening element configured to be fastened by a first fastening part formed by plastic deformation of an inner surface of the pump housing at an entrance of a lower chamber defined in the pump housing, and the valve body having a second fastening element which is spaced apart from the first fastening element and is configured to be fastened by a second fastening part formed by plastic deformation of the inner surface of the pump housing;
a plunger seat positioned within the valve body, wherein the plunger receives a hydraulic pressure supplied by the master cylinder so as to supply oil through the flow path forming holes of the valve body;
a spring elastically provided between the plunger and the plunger seat;
a main check valve configured to open and close the flow paths by allowing selective contact between the contact end of the plunger and the plunger, thereby selectively allowing and preventing the flow of hydraulic pressure from the plunger seats through the valve body, and to the brake mechanism;
a return check valve configured to return oil in an axial direction which is parallel to an axis of the plunger seat and is perpendicular to the flow path forming holes; and
an edge of a bottom of the lower chamber of the pump housing is formed with an inclined support, such that, with the valve body fitted into the pump housing, a proximal end of the front filter inserted into the lower chamber of the pump housing abuttingly engages the inclined support.

2. The solenoid valve as set forth in claim 1, further comprising:
a support inserted into the valve body and positioned adjacent to the plunger seat so as to support the plunger seat; and
a front filter coupled to a distal end of the valve body, the front filter being configured to remove impurities contained in oil and fitted into the pump housing so as to be supported by the pump housing.

3. The solenoid valve as set forth in claim 1, wherein the valve body comprises an elongate body part secured to an armature housing which surrounds the armature, a first flow path forming body part formed integrally with the elongate body part and fitted into and fastened to the pump housing, a fastening flange formed between the elongate body part and the first flow path forming body part, the fastening flange having a larger diameter than a diameter of the pump housing, the flow path forming holes radially extending within the first flow path forming body part so as to communicate with the plunger receiving chamber which extends axially through center portions of the elongate body part and the first flow path forming body part, the flow path forming holes supplying hydraulic pressure to the brake mechanism, and a returning flow path axially extending parallel to the plunger seat which is positioned axially within the plunger receiving chamber of the valve body, and the return flow path extending perpendicularly to the flow path forming holes to provide a return passage when oil is returned.

4. The solenoid valve as set forth in claim 1, wherein the plunger seat comprises a second flow path forming body part which defines an oil introduction chamber into which oil is introduced from the master cylinder, and an elongate contact end projecting from a distal end of the second flow path forming body part so as to define a guide hole which communicates with the oil introduction chamber.

5. The solenoid valve as set forth in claim 1, wherein the main check valve comprises a first spherical check ball, which is accommodated in a first accommodating provided at the contact end of the plunger, and opens and closes the flow path depending upon a degree of contact with the plunger seat.

6. The solenoid valve as set forth in claim 5, wherein an end surface of the contact end of the plunger, in which the first spherical check ball is accommodated, and an end surface of the elongate contact end of the plunger seat, which come into contact with each other, are formed in an arc shape.

7. The solenoid valve as set forth in claim 1, wherein the return check valve comprises a second spherical check ball which is accommodated in a second accommodating groove provided at an end of the returning flow path extending axially and parallel to the plunger seat the plunger seat being positioned axially within the plunger receiving chamber of the valve body, and the return flow path extending perpendicular to the flow path forming holes.

8. (canceled)

9. The solenoid valve as set forth in claim 8, wherein a portion of the pump housing which defines the lower chamber is made of aluminum which has a relatively low yield strength.

10. The solenoid valve as set forth in claim 8, wherein the first fastening element is formed on a circumferential outer surface of the fastening flange, the fastening flange having a larger diameter than the first flow path forming body part of the valve body fitted into the pump housing.

11. The solenoid valve as set forth in claim 10, wherein the first fastening element has a larger diameter than the fastening flange.

12. The solenoid valve as set forth in claim 8, wherein the second fastening element comprises a plurality of grooves spaced at regular intervals on a circumferential outer surface of the first flow path-forming body part of the valve body.

13. The solenoid valve as set forth in claim 12, wherein each groove has a V-shaped section.

14. The solenoid valve as set forth in claim 12, wherein a distal end portion of the first flow path-forming body part, which does not have the second fastening element defined therein, has a diameter which is smaller than that of a portion of the first flow path forming body part, which has the second fastening element defined therein.

15. (canceled)
